(19) United States
(12) Patent Application Publication
(10) Pub. No.: US 2015/0081946 A1
(43) Pub. Date: Mar. 19, 2015

(54) METHOD OF IN-MEMORY MODIFICATION OF A DATA SET

(71) Applicant: MORPHO, Issy-Les-Moulineaux (FR)

(72) Inventors: Francois Lecocq, Issy-Les-Moulineaux (FR); Cyrille Pepin, Issy-Les-Moulineaux (FR)

(73) Assignee: MORPHO, Issy-Les-Moulineaux (FR)

(21) Appl. No.: 14/389,886

(22) PCT Filed: Mar. 19, 2013
(86) PCT No.: PCT/EP2013/055737

§ 371 Date: Dec. 9, 2014

(30) Foreign Application Priority Data
Apr. 2, 2012 (FR) 12/52989

(51) Int. Cl. G06F 11/14; G06F 12/02

(52) U.S. Cl. CPC G06F 11/1451; G06F 12/0238; G06F 2212/7208; G06F 2212/202
USPC 711/102

(57) ABSTRACT

The present invention relates to the field of the management of memory writes to an information processing device and more precisely to a method of writing a set of data in a unitary and coherent manner. The invention, although of more general scope, applies more particularly in the field of chip cards.

There is described a method of writing one or more data to the memory of an information processing device which comprises a step of copying a so-called original memory block comprising the data to be written to a so-called backup memory block. The data writing step is then carried out in the original memory block or in the backup memory block. It is then always possible to return if necessary to the values of the original data if the writing phase fails.

The present invention concerns the field of the management of memory writes of an information processing device and more precisely a method of writing a set of data in a unitary and coherent manner. The invention, although of more general scope, applies more particularly in the field of smartcards.

It is wished to avoid the writing of a data item being able to be interrupted and the memory space of the data item being in an undetermined transient state that makes the data unusable.

It is sometimes wished to write a set of linked data to memory. In this case, the data must be written completely or not at all. It is necessary to avoid some data items being able to be written and not the others.

It is also sometimes wished to accumulate data modifications and to validate all these modifications only when an event occurs.

The invention aims to solve the above problems by means of a method for writing one or more data items in a memory of an information processing device that comprises a step of copying a so-called original memory block comprising the data item or items that are to be written in a so-called backup memory block. The data writing step is then performed in the original memory block or in the backup memory block. It is then always possible to return if necessary to the values of the original data if the writing phase fails.

The invention concerns a method for modifying in memory a set of data that comprises the following steps in an information processing device: a step of defining one or more memory blocks containing the data that are to be modified, the memory space containing the data to be modified being referred to as the original memory space, the memory block or blocks thus defined being referred to as original memory blocks; a step of copying said original memory blocks into a memory space referred to as the backup memory space, the blocks thus modified being referred to as backup blocks; a step of modifying the data in the original memory blocks and, in the event of failure of the modification operation before it ends, a step of copying said backup blocks on the original blocks in order to ensure that the modification of all the data, referred to as a transaction, is performed in a unitary and coherent manner.

According to a particular embodiment of the invention, the original and backup memory spaces being non-volatile memory spaces, the method further comprises a step of storing in non-volatile memory a state associated with each transaction among the following states: an “off-transaction” state when the transaction is not in progress; a “modifications in progress” state in which the modifications associated with the transaction are in progress, and a “copying in progress” state in which a copying of the backup blocks on the original blocks is in progress and a restoration step when the electrical supply returns following loss thereof, which consists of copying the backup blocks on the original blocks if the backup state is the “modification in progress” or “copying in progress” state.

The invention also concerns a method comprising the following steps in an information processing device: a step of defining one or more memory blocks containing the data that are to be modified, the memory space containing the data to be modified being referred to as the original memory space, the memory block or blocks thus defined being referred to as original memory blocks; a step of copying said original memory blocks into a memory space referred to as the backup memory space, the blocks thus modified being referred to as backup blocks; a step of modifying the data in the backup memory blocks and, in the event of success of the modification operation, a step of copying said backup blocks on the original blocks in order to ensure that the modification of all the data, referred to as a transaction, is performed in a unitary and coherent manner.

According to a particular embodiment of the invention, the original and backup memory spaces being non-volatile memory spaces, the method further comprises a step of storing in non-volatile memory a state associated with each transaction among the following states: a “off transaction” state in which the transaction is not in progress; a “modifications in progress” state in which the modifications associated with the transaction are in progress, and a “copying in progress” state in which a copying of the backup blocks on the original blocks is in progress and a restoration step when the electrical supply returns following loss thereof, which consists of copying the backup blocks on the original blocks if the backup state is the “copying in progress” state.

According to a particular embodiment of the invention, two transactions having an temporal overlap and a physical overlap, that is to say the memory blocks associated with the two transactions overlap, the intersection defining an overlap block, the method further comprises a step of computing the difference between the original overlap block and the block issuing from the modifications made by the first transaction ending and a step of applying this difference in the backup memory block associated with the other transaction.

According to a particular embodiment of the invention, the memory blocks have a fixed size.

The invention also concerns an information process device that comprises, for an in-memory modification of a set of data, means for defining one or more memory blocks containing the data that are to be modified, the memory space containing the data to be modified being referred to as the original memory space, the memory block or blocks thus defined being referred to as original memory blocks, means for copying said original memory blocks into a memory space referred to as the backup memory space, the blocks thus modified being referred to as backup blocks; means for modifying data in the original memory blocks and, in the event of failure of the modification operation before it ends, means for copying said backup blocks on the original blocks in order to ensure that the modifications of the set of data, which are referred to as a transaction, are performed in a unitary fashion.

The invention also concerns an information processing device, characterised in that it comprises, for an in-memory modification of a set of data, means for defining one or more memory blocks containing the data that are to be modified, the memory space containing the data to be modified being referred to as the original memory space, the memory block or blocks thus defined being referred to as original memory blocks, means for copying said original memory blocks into a memory space referred to as the backup memory space, the blocks thus modified being referred to as backup blocks; means for modifying data in the original memory blocks and, in the event of success of the modification operation, a means for copying said backup blocks on the original blocks in order to ensure that the modifications of the set of data, referred to as a transaction, are performed in a unitary fashion.

The features of the invention mentioned above, as well as others, will emerge more clearly from a reading of the following description of an example embodiment, said description being given in relation to the accompanying drawings, among which:

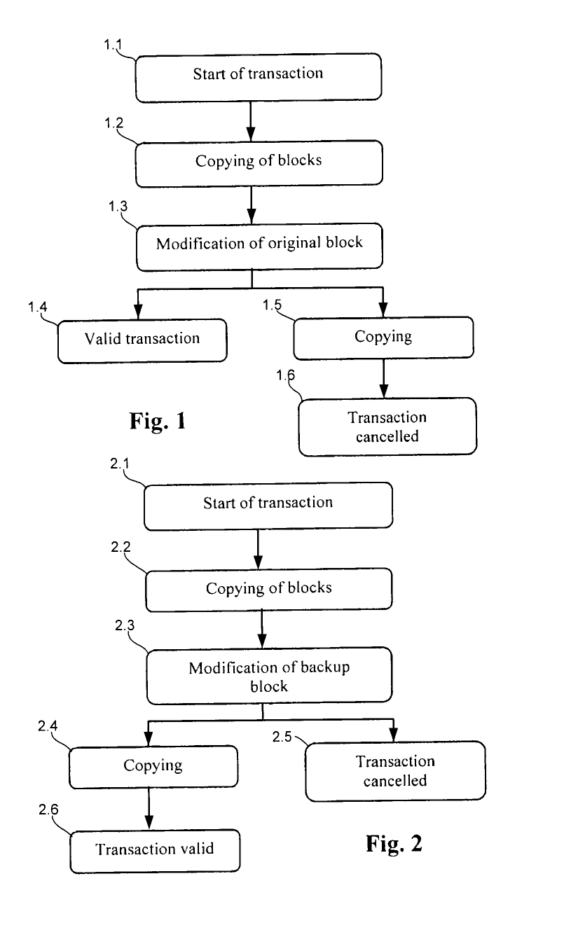

FIG. 1 illustrates the operating flow diagram of a first embodiment of the invention,

FIG. 2 illustrates the operating flow diagram of a second embodiment of the invention, and

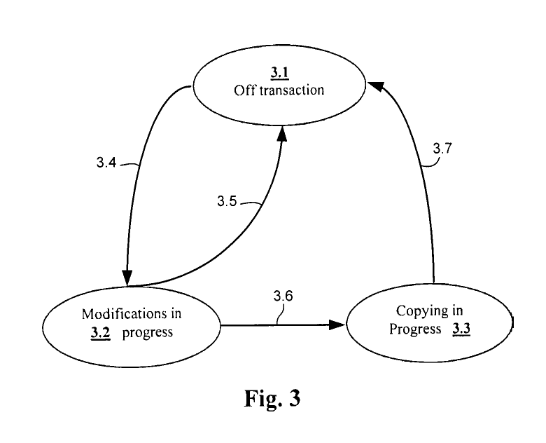

FIG. 3 illustrates the state machine used in one embodiment of the invention.

The data manipulated by the information processing device are typically stored in memory spaces. These memory spaces can be seen as monodimensional tables of memory elements. Each memory element contains a defined number of bits, the same for all the memory elements. The index in the table is defined as the memory address of the element. The sizes of the memory elements normally used today make 32 or 64 bits.

A data item is therefore stored in one or more memory elements according to the size thereof. These memory elements are typically contiguous. When it is wished to modify a data item, one performs the write of its new value in a memory element or elements wherein this data item is stored.

A transaction is defined, in the context of this document, as a set of data writes that are to be performed in a unitary manner. What is meant by this is that this set of data writes must be performed either entirely or not at all. It is sought to avoid that a partial writing of this set of data can occur (for example, the updating of a data item and the associated integrity).

Memory block means a contiguous memory space that contains all or some of the data to be written during a transaction. The memory block may serve as a memory manipulation unit for the transition system that is described. The size of the memory block can be defined in various ways. A first way consists of statically fixing the size of the memory block within the system. All the memory blocks then have the same size. Management of the memory blocks is then facilitated, but on the other hand it may be necessary to work with several different memory blocks for the same transaction. One normally speaks of memory pages instead of memory blocks in the case of blocks of fixed size and of a paginated memory.

The size of the memory block may be variable and dependent on the data to be modified. The size of a block is then defined as the smallest memory space encompassing the data of the same transaction, and this for each transaction. Management is then more complex, but more optimum in terms of consumption of memory.

FIG. 1 illustrates a first embodiment of the invention. During a first step 1.1 the transaction is started. Step 1.2 consists of copying the memory block or blocks that contain the data which the transaction relates to. These data are the data that have to be modified in a unitary fashion defining the transaction. For each of the memory blocks thus processed, the original block is therefore defined. This original block is the memory block containing the data item to be modified. The original memory block is copied in a memory space that is referred to as the backup memory space. The copied memory block is therefore referred to as the backup memory block. At the end of this step, an identical copy of the memory block or blocks containing the data to be modified is therefore available.

During step 1.3, data modifications associated with this transaction occur. This step may last for a certain length of time and depends on the definition of the transaction. The memory writes are done, in this first embodiment of the invention, in the original memory space. It is therefore the original memory blocks that contain the data modified by the transaction.

If nothing interferes with this data modification step, a transaction validation occurs at the end thereof. Step 1.4 is then performed. The data modifications having been done directly in the original memory space, no intervention is necessary in this space. The transaction ends by being validated and the backup memory space can be released.

At any moment during this modification step, it may happen that the transaction is cancelled. The reasons for such cancellation depend on the application and are not developed here. In this case step 1.5 is now performed. Since the transaction has not been able to end, it is necessary to restore the original memory space to the state in which it was before the start of the transaction. Step 1.5 therefore consists of copying the memory block or blocks of the backup space in the corresponding blocks of the original memory space. At the end of this copying, the backup memory space can be released.

The end-of-transaction state 1.6 is then performed. The cancelled transaction has not caused any modification to the original memory space that has been restored.

It is found that the aim that had been determined, that is to say to enable a set of memory writes to take place in a unitary fashion, is indeed achieved.

FIG. 2 illustrates a second embodiment of the invention. This second embodiment is similar to the first. Steps 2.1 and 2.2 are identical to their counterparts 1.1 and 1.2 of the first embodiment.

Step 2.3 differs from step 1.3 through the choice of the memory space in which the modifications take place. In this second embodiment, the choice relates to the backup memory space. The modification step 1.3 therefore leaves the original memory space unchanged.

This choice has an impact on the operations to be undertaken during the validation of the transaction and also during the cancellation.

In the case of a validation of the transaction, it is now necessary to perform a step 2.4 of copying from the backup memory space to the original memory space so as to transfer the modifications to the data actually stored in this space. Step 2.6 then validates the transaction.

In the case where the transaction is cancelled, the original space not having been modified, there is no operation to be undertaken in this space. The backup memory space is released and the transaction ends on a cancelled state during step 2.5.

This embodiment enables to achieve the same aim as the first one, the major difference solely relating to the use of the original and backup blocks.

It may be advantageous to offer a memory write mechanism that is also resistant to a break in the power supply to the device. It is then necessary to distinguish two types of memory functioning. The memories used in an information processing device may be of the volatile type. This type of memory then requires being supplied electrically to store its content. A loss of supply leads to a total loss of the information stored. A second type of memory consists of a non-volatile memory type. In this case, the loss of an electrical supply does not cause loss of the stored data. Both types of memory may cohabit within the same information-processing device; this is even the most general case. Typically a chip card stores data in a memory of the non-volatile type but has a volatile working memory space. This is because the access time to the volatile memory is very appreciably greater than the access time to a non-volatile memory.

Both first embodiments function whatever the type of memory. If we wish to make them resistant to a loss of supply, it is necessary to be concerned with the type of memory to be considered. The resistance of the transaction mechanism to a loss of supply means that the original memory space is in a non-volatile memory. This is because, in the contrary case, all the data are lost during the loss of supply and the invention no longer has any meaning. In the same way, the backup memory space must also be in non-volatile memory so as to allow copying of the block following a break in supply.

To make the transaction mechanism resistant to a loss of supply, we are going to define a states machine. This states machine is described in FIG. 3. A first state 3.1 is defined that corresponds to an off-transaction state. In this state, no transaction is in progress. A start of transaction 3.4 makes the system go into the state 3.2 that corresponds to the state in which the modifications associated with a transaction are in progress. This is the case of the first embodiment where the modifications take place in the original memory space. Validation of the transaction 3.5 then takes us to the off-transaction state. The modifications are valid in the original memory space. Cancellation of the transaction 3.6 then takes us to the state 3.3 of copying in progress. This is the state in which the copying of the backup memory space to the original memory space occurs. When the copying 3.7 ends, the off-transaction state 3.1 is passed to.

In the case of the second embodiment where the modifications take place in the backup memory space, the states machine is almost the same. The only differences are reversal of the wordings 3.5 and 3.6. The state of copying in progress is passed to on a validation 3.6 of the transaction, the backup memory space where the modifications take place then having to be copied to the original memory space. It is during a cancellation 3.5 of the transaction that the off-transaction state 3.1 is passed to directly.

The method according to the invention then also comprises a step of storing the current state in a non-volatile memory. In this way, whatever the moment when a power cut occurs, the state of the system with respect to this machine is stored and can be found again when the device regains an electrical supply.

The method also further comprises a restoration step when the supply returns.

This restoration step will perform a set of operations according to the stored state of the system and the operating mode of the transaction mechanism. The operating mode is the mode of modification in original memory or backup memory.

If the system is in the off-transaction state, and whatever the operating mode, there is no operation to undertake.

If the system is in the in progress modifications state and if the modifications take place in the original memory, it is necessary to copy the backup memory to the original memory in order to cancel the interrupted transaction. The system goes into the in progress copying state during this operation.

If the system is in the in progress modifications state and if the modifications take place in the backup memory, there is nothing to do.

If the system is in the “in progress copying” state, since it is not possible to know the state of progress of the copying, the latter is reset to zero. The backup memory space is then fully copied on the original memory space. The system remains in the in progress copying state.

At the end of this step, the system does indeed comply with the constraint of the transaction, that is to say all the writings related to the transaction are fully or not at all performed.

The system can manage as such any number of transactions. It is then necessary to manage as many states machines as there are simultaneous transactions. Simultaneous transaction means two transactions having at least a partial temporal overlap. Only one condition has however to be complied with in order to ensure correct functioning; it is not possible to have two transactions having simultaneously an temporal overlap and a physical overlap, the physical overlap meaning that the memory blocks associated with the two transactions overlap. This restriction applies to both embodiments.

Actually, risk is then taken that a block copying performed by one of the transactions invalidates the modifications made by the other transaction. Let us take the case where the modifications are performed in the original memory space. The two transactions will make their writings in the same original space, which does not pose any problem since they do not seek to modify the same memory element. However, if one of the transactions fails, it will copy the backed-up memory block, thus potentially cancelling the modifications made by the other transaction.

In the other operating mode, each transaction copies its memory block in the backup memory space. The common part is therefore duplicated in the backup space. This transaction makes its modifications on its copy. The first transaction that ends copies its memory block in the original space. When the second transaction ends, it does likewise, thus deleting the modifications made by the first transaction in the common part. This drawback occurs even in the case where the two transactions does not touch however the same memory elements, but adjoining memory elements situated in a common part, which corresponds to the same memory block.

To solve this problem, a novel advantageous embodiment is developed. This novel mode is restricted to the functioning of the transitions where the modifications take place in the backup memory space. Thus, when two transactions temporally and physically overlap, each of both makes its own copy of the memory block or blocks that concern it and each makes its modifications on its own copy.

The concept of overlap block is defined, the memory space common to the memory blocks associated with the two transactions.

The method according to this embodiment comprises an additional step that occurs before the copying of the memory block associated with the first transaction ending. It comprises a step of computing the difference between the original overlap block and the one issuing from the modifications made by the first transaction ending. It also comprises a step of applying this difference in the backup memory block associated with the other transaction.

Thus the modifications made by the first transaction in the common part are transferred onto the working block of the second. The copying of this working block at the time of the validation of the second transaction will therefore transfer the modifications made by the first transactions instead of deleting them in the original memory space. If the second transaction fails and this block is not copied in memory, the modifications made by the first transaction that were copied in the original memory space remain valid.

The only case that is not addressed is the case where the two transactions modify the same memory element differently. This case is not, a priori, soluble, since the same memory element cannot have two different values at the end of the two transactions. In this case, the modification of the first memory element made by the second transaction will prevail.

The reader will understand that the management of the overlap and the mechanism of the latter embodiment is greatly facilitated in the case of paginated memory and therefore blocks of fixed size. The overlap blocks then consist of an integer number of pages.

1. A method for in-memory modification of a set of data, comprising the following steps in an information processing device:
defining one or more memory blocks containing a set of data to be modified, the memory space containing the set of data to be modified being referred to as the original memory space, such that the memory block including the set of data to be modified is referred to as original memory blocks;
copying said original memory blocks into a non-volatile backup memory, the blocks thus modified being referred to as backup blocks;
modifying the set of data in the original memory blocks;
storing in the non-volatile backup memory a transaction state among the following states
an “off-transaction” state when no transaction is in progress,
an “in progress modifications” state stored when a transaction in progress implements a data modification step in the original memory blocks, and
an “in progress copying” state stored when a transaction implements a copying of the data blocks of the backup memory space to the original memory space in order to cancel the interrupted transaction; and
restoring the original memory space to the state in which the original memory space was in before receiving an interrupt as a function of the stored transaction state and the operating mode of the transaction mechanism, wherein
when the stored transaction state is “off-transaction” state, the information processing device does nothing,
when the stored transaction state is “in progress modification” state, the information processing device performs a copying of the data blocks of the backup memory space to the original memory space, and
when the stored transaction state is “in progress copying” state, the information processing device performs a copying of the data blocks of the backup memory space to the original memory space.

2. A method for in-memory modification of a set of data, comprising the following steps in the information processing device:
defining one or more memory blocks containing a set of data to be modified, the memory space containing the set of data to be modified being referred to as the original memory space, such that the memory block including the set of data to be modified is referred to as original memory blocks;
copying said original memory blocks into a non-volatile backup memory, the blocks thus defined being referred to as backup blocks;
modifying the set of data in the backup memory blocks;
copying in the original memory space the modified backup memory blocks; and
storing in the non-volatile backup memory a transaction state among the following states
an “off-transaction” state when no transaction is in progress,
an “in progress modifications” state stored when a transaction in progress implements a data modification step in the original memory blocks, and
an “in progress copying” state stored when a transaction that has successfully implemented a modification step now implements a step of copying the data blocks from the backup memory space to the original memory space; and
restoring, when the power supply to said information processing device returns after it has been cut off, wherein
when the stored transaction state is “off-transaction” state, the information processing device does nothing,
when the stored transaction state is “in progress modification” state, the information processing device does nothing, and
when the stored transaction state is “in progress copying” state, the information processing device performs a copying of the data blocks of the backup memory space to the original memory space.

3. The method according to claim 2, the method further comprising:
calculating the difference between an original overlap block and the overlap block issuing from the modifications made by the first transaction ending; and
applying this difference in the backup memory block associated with a second transaction,
wherein an overlap block is an intersection between two transactions having a temporal overlap and a physical overlap, such that the memory blocks associated with the two transactions overlap.

4. The method according to claim 3, wherein the memory blocks have a fixed size.

5. An information processing device, comprising:
circuitry configured to
define one or more memory blocks containing a set of data to be modified, the memory space containing the set of data to be modified being referred to as the original memory space, such that the memory block including the set of data to be modified is referred to as original memory blocks,
copy said original memory blocks into a non-volatile backup memory, the blocks thus defined being referred to as backup blocks,
modify the set of data in the original memory blocks,
store in the non-volatile memory a transaction state among the following states
an “off-transaction” state when no transaction is in progress,
an “in progress modifications” state stored when a transaction in progress implements a data modification step in the original memory blocks, and
an “in progress copying” state stored when a transaction implements a copying of the data blocks of the backup memory space to the original memory space in order to cancel the interrupted transaction, and
restore the original memory space to the state in which the original memory space was in before receiving an interrupt as a function of the stored transaction state and the operating mode of the transaction mechanism, wherein
when the stored transaction state is “off-transaction” state, the information processing device does nothing,
when the stored transaction state is “in progress modification” state, the information processing device performs a copying of the data blocks of the backup memory space to the original memory space, and
when the stored transaction state is “in progress copying” state, the information processing device performs a copying of the data blocks of the backup memory space to the original memory space.

6. An information processing device comprising:
circuitry configured to
define one or more memory blocks containing a set of data to be modified, the memory space containing the set of data to be modified being referred to as the original memory space, such that the memory block including the set of data to be modified is referred to as original memory blocks,
copy said original memory blocks into a non-volatile backup memory, the blocks thus defined being referred to as backup blocks,
modify the set of data in the backup memory blocks, and
copy in the original memory space the modified backup memory blocks,
store in the non-volatile memory a transaction state among the following states
an “off-transaction” state when no transaction is in progress,
an “in progress modifications” state stored when a transaction in progress implements a data modification step in the original memory blocks, and
an “in progress copying” state stored when a transaction that has successfully implemented a modification step now implements a step of copying the data blocks from the backup memory space to the original memory space, and
restore, when the power supply to said information processing device returns after it has been cut off, wherein
when the stored transaction state is “off-transaction” state, the information processing device does nothing,
when the stored transaction state is “in progress modification” state, the information processing device does nothing, and
when the stored transaction state is “in progress copying” state, the information processing device performs a copying of the data blocks of the backup memory space to the original memory space.
